(19) United States
(12) Patent Application Publication
(10) Pub. No.: US 2009/0238086 A1
(43) Pub. Date: Sep. 24, 2009

(54) Rank Dependent CQI Back-Off

(75) Inventors: Markus Ringstrom, Stockholm (SE); Ari Kangas, Lidingo (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/171,937

(22) Filed: Jul. 11, 2008

Related U.S. Application Data
(60) Provisional application No. 61/037,769, filed on Mar. 19, 2008.

(51) Int. Cl. H04L 12/26

(52) U.S. Cl. 370/252

(57) ABSTRACT

In a wireless communication network UE, an estimated signal to interference and noise ratio (SINR) is calculated for each potential transmission mode, and is reduced by a calculated SINR back-off value in response to errors detected in decoding data in each of a plurality of data streams. A Channel Quality Indicator CQI is then generated based on the reduced SINRs. Reducing the SINR estimates in the presence of known data errors allows a UE to more accurately track a target BLER.

The present invention claims priority to U.S. provisional patent application Ser. No. 61/037,769, entitled “Rank Dependent CQI Back-off,” filed Mar. 19, 2008, and incorporated herein by reference in its entirety.

### FIELD OF THE INVENTION

The present invention relates generally to wireless communication networks, and in particular to a receiver generating SINR back-off values for each transmission mode in the event of data decoding errors.

### BACKGROUND

Wireless communication systems are required to transmit ever-increasing amounts of data, in support of expanded subscriber services, such as messaging, e-mail, music and video streaming, and the like. Transmitting a higher volume of data over a given channel requires transmission at a higher data rate.

One known technique to improve data transmission rates in wireless communications is the use of multiple input, multiple output (MIMO) technology, wherein signals are transmitted from multiple transmit antennas and may be received by multiple receiver antennas. Using advanced coding and modulation schemes, two or more streams of data may be transmitted simultaneously to a receiver, increasing the data rate.

Maintaining high data rates in MIMO systems requires fast scheduling and link adaptation. That is, the transmitter must constantly alter its selection of packets to transmit, and its transmission parameters based on the current characteristics of the channel, which can change rapidly. In a Frequency Division Duplex (FDD) system, the instantaneous downlink channel conditions are not available at the base station, and must be determined by a receiver and communicated to the base station. In Wideband CDMA (WCDMA) and Long Term Extension (LTE), the instantaneous downlink channel conditions are communicated to the base station through a Channel Quality Indicator (CQI).

Estimating the CQI is a delicate task, comprising a number of computational steps, each considering a large number of factors. The transport format selection process at the transmitter is very sensitive to CQI estimation errors. Accordingly, a targeted Block Error Rate (BLER) might be difficult to achieve with poor CQI estimation.

CQI estimation may involve a suggested selection, based on instantaneous channel conditions, of the modulation and coding rate and transport block size that the receiver can support with a given BLER. For MIMO systems, the suggested selection may also include the number of transmitted streams and the optimal preceding matrix.

The capacity that can be supported by a known channel, with additive white Gaussian noise with known variance, is well known. In practice, however, a number of phenomena add to the CQI estimation errors. One error source is the delay between the measurement of CQI and the time the actual transmission takes place. During this period, the channel and interference may change significantly.

Another source of error is channel and noise/interference estimation errors. Channel estimation quality depends on the SNR, delay and Doppler spread, and the power allocated to reference symbols. Channel estimation errors affect not only the SNR calculation for CQI, but also the demodulation performance, and in a way that could be difficult to model. Interference estimation should thus ideally be based on measurements on data channels, and not reference symbols. This is especially the case for orthogonal frequency division multiplex (OFDM) systems like LTE, since the interference situation may be different on reference symbols than on data symbols. However, this may not be feasible since it may be hard to distinguish the signal coming from a receiver's own cell from signals transmitted by the neighbor cells.

One potential solution to improve CQI estimation would be to measure the performance of the UE in various conditions, including SNR, delay and Doppler spread, MIMO transmission mode, different reference symbol powers, bandwidth, and the like. The result could be stored in tables, and multidimensional interpolation employed to determine the CQI for the prevailing conditions. However, due to the large number of parameters affecting CQI, such tables may become prohibitively large, and still may not capture all effects.

### SUMMARY

According to one or more embodiments of the present invention, an estimated signal to interference and noise ratio (SINR) calculated for each potential transmission mode, is reduced in response to errors detected in decoding data in each of a plurality of data streams. A Channel Quality Indicator CQI is then generated based on the reduced SINRs. Reducing the SINR estimates in the presence of known data errors allows a UE to more accurately track a target BLER.

One embodiment relates to a method of reporting channel quality in a wireless communication system operative to transmit signals in a plurality of modes, each mode transmitting data in one or more streams. Data and reference signals are received in at least one stream, and the data for each stream are decoded. A data error indicator is generated for each stream based on the decoded data. Channel and noise estimates are generated, and a SINR is generated for each potential transmission mode based on the channel and noise estimates. An SINR back-off value is generated for each transmission mode in response to the data error indicators. Each SINR is reduced by the corresponding SINR back-off value. A CQI is calculated based on the reduced SINRs, and the CQI is transmitted.

### BRIEF DESCRIPTION OF THE DRAWINGS

FIG. 1 depicts the downlink signal paths in a MIMO wireless communication network 10. A User Equipment (UE) 12, such as a mobile transceiver, receives signals on one or more receive antennas 14, 16. The signals are transmitted from one or more transmit antennas 18, 20. Each signal path experiences different channel conditions, which include impairment effects such as fading, interference, noise, and the like. In general, each channel is unique, as indicated. As known in the art, the transmitters 18, 20 transmit known reference symbols, also referred to as pilot symbols, at known positions within a data frame, to facilitate measurement of the channel conditions by the UE 12. Channel and noise estimates are thus available at the pilot positions.

FIG. 2 depicts the CQI estimation and feedback path in the UE 12. Downlink signals are received at one or more receive antennas 14,16, and are processed by receiver front-end circuits 34. Data symbols are demodulated and decoded at block 36. A data error indicator, such as the result of a Cyclic Redundancy Check (CRC), is sent to the transmitter as a positive or negative acknowledgment signal, ACK or NAK, respectively. The ACK/NAK is encoded and modulated at block 42 and forwarded to a transmitter front-end circuit 46 for transmission at the antenna(s) 14, 16. The data are further processed, such as rendered into speech or audio, displayed as text or video, processed as commands, or the like, in various circuits in the UE 12 (not shown).

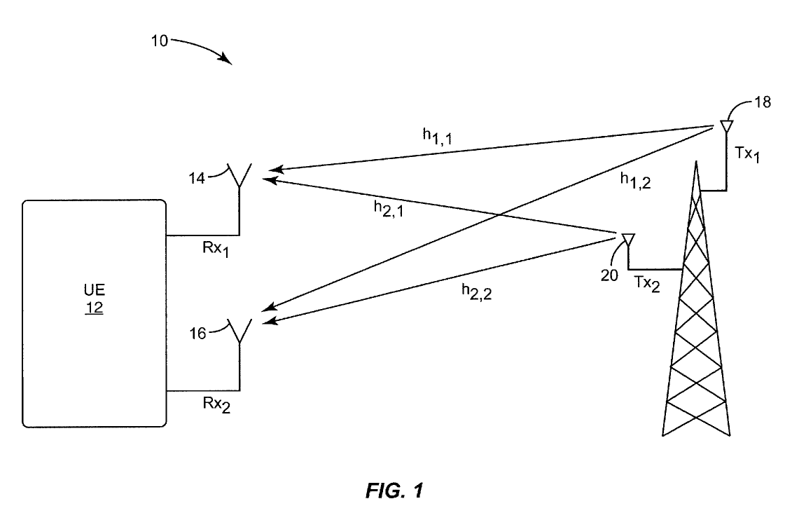

Pilot signals are provided by the receiver front-end circuits 34 to a channel estimation function 38. The channel estimator 38 generates channel noise and interference estimates, and provides these to the demodulator and decoder function 36, so that it can detect the received data symbols. The channel estimator 38 additionally provides a SINR to the CQI estimator function 40, which estimates a CQI for transmission to the base station for link adaptation. The CQI is provided to an encoder and modulator function 44. Encoded and modulated CQI data are processed by a transmitter front-end 46 and other circuits, and the modulated CQI estimate is transmitted to the base station on one or more antennas 14, 16.

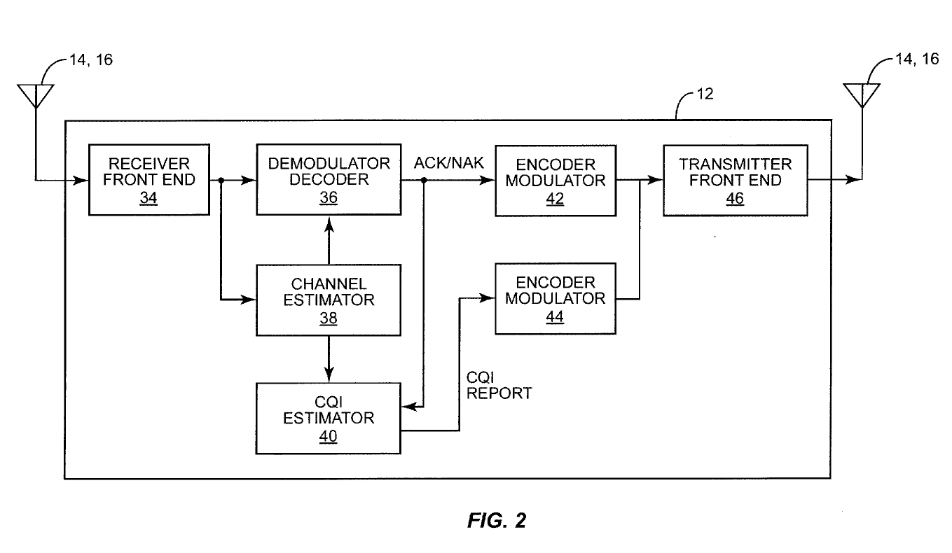

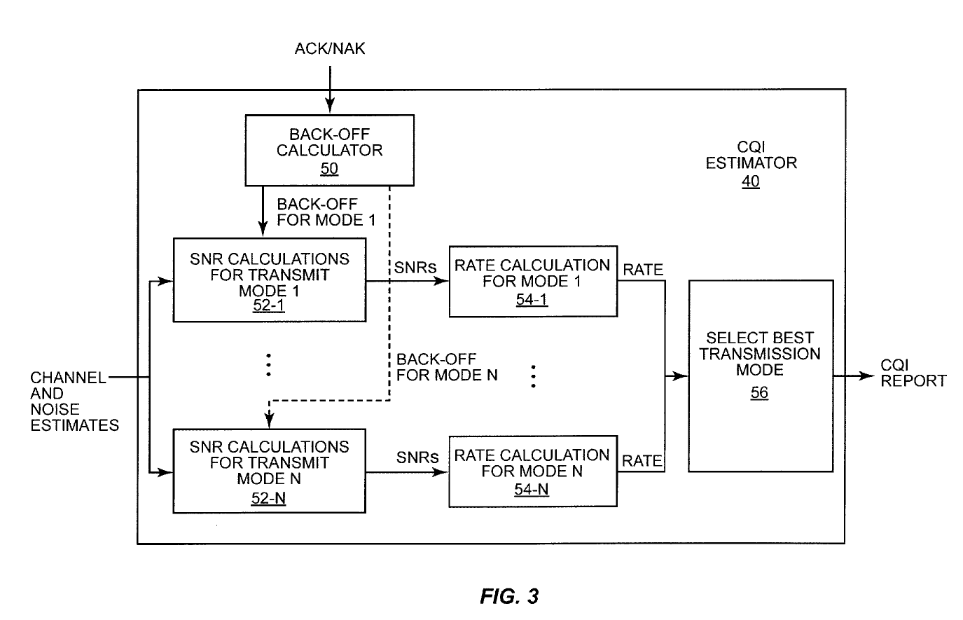

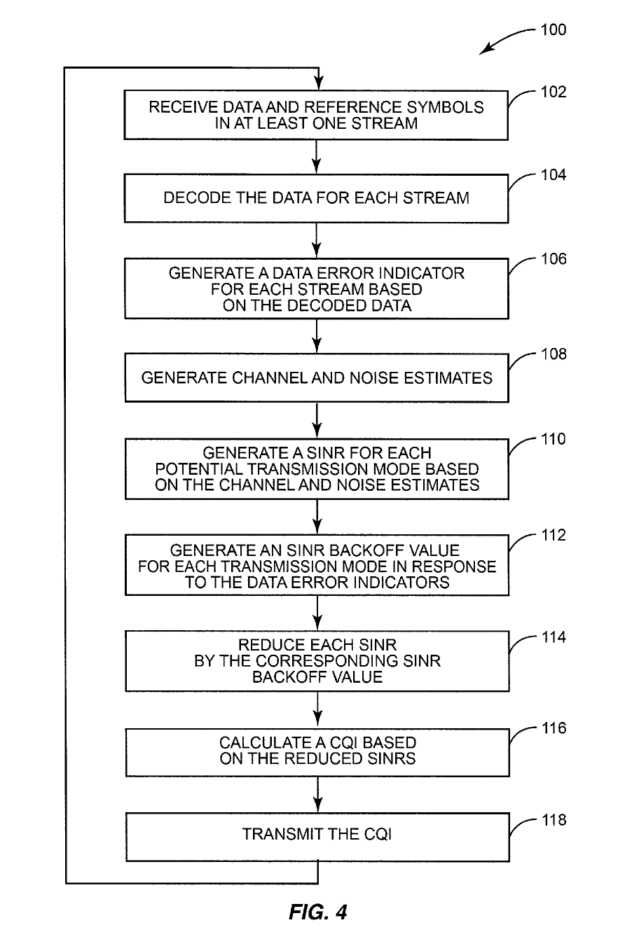

According to one or more embodiments disclosed herein, in order to control the BLER, a back-off strategy is employed to adjust the SINR before it is used to calculate the CQI. As a consequence, the BLER will be closer to the targeted BLER. The input to the calculation of the SINR back-off is whether the latest data packet for each stream was received correctly. This is indicated by a data error indicator, such as the ACK/NAK indicator resulting from the CRC check. As depicted in FIG. 2, the ACK/NAK indicator is provided from the demodulator and decoder 36 to the CQI estimation function 40.

Each time a SINR value is calculated in order to update the CQI, it is adjusted by an SINR back-off value. The SINR back-off depends on the transmission mode, which means that the back-off is calculated separately, and may be different, for different transmission modes. The SINR back-off is updated every time a data verification operation, such as a CRC check, is performed. The only input needed is the latest data error indicator. One possible implementation of the SINR back-off calculation is described below.

First, determine the instantaneous BLER in the current TTI (Transmission Time Interval), averaged over all data streams transmitted. Based on the instantaneous BLER, adjust the SINR_back-off for the current transmission mode. The adjustment, positive or negative, is made to achieve a long term BLER rate equal to a predetermined BLER target. The adjustment is positive if the instantaneous BLER rate is larger than the BLER target, and negative otherwise. Also, the adjustment is done in small steps in order to avoid too large fluctuations in the SINR_back-off. There is a delay of several TTIs from the transmission of an uplink CQI report until data can be sent in the downlink. During that delay the downlink transmitter does not know anything about performance of recent transmissions, so there is no point in doing too fast adjustments during this delay. To summarize, when determining the amount of adjustment the UE should take the CQI delay into account. Finally, make sure that the SINR back-off does not exceed the maximum allowed value or is lower than the minimum allowed value

An additional restriction is that if the maximum modulation and coding scheme is chosen for the transmission on any stream, the SINR back-off saturates and should not be reduced for the current transmission mode.

While the SINR back off is described above as being dependent on the transmission mode, this is not necessarily the case. For example, for a receiver employing Successive Interference Cancellation (SIC), the SINR back-off may be applied in the general case when different data streams originate from different users. In the case of a MIMO receiver, the SINR back-off could be different for the different code words, since it is likely that the first code word is not perfectly cancelled, and hence the theoretical performance can not be achieved in reality.

FIG. 3 depicts the CQI estimator function 40 in greater detail. An SINR back-off value is calculated for each transmission mode in a back-off calculating function 50, based on the data error indicator for each stream (e.g., the ACK/NAK resulting from a CRC check). The SINR back-off values are provided to SNR calculation functions 52-1, . . . , 52-n for each transmission mode. Rate calculation functions 54-1, . . . , 54-n then calculate the maximum data rate for each transmission mode that achieves the target BLER. These at data rates are then considered by the transmission mode selection function 56, which formats and outputs the selection as a CQI estimate.

FIG. 4 depicts a method 100 of reporting channel quality. A UE 12 receives data and reference symbols in at least one data stream (block 102). The data for each stream is decoded (block 104), and a data error indicator is generated if a data integrity operation, such as a CRC check, indicates an error (block 106). The UE 12 generates channel and noise estimates based on the reference symbols (block 108), and generates a SINR for each potential transmission mode, based on the channel and noise estimates (block 110). An SINR back-off value is generated for each transmission mode in response to the data error indicators (block 112). The SINR values for each transmission mode are reduced (or, if a negative value, increased) by the respective SINR back-off values (block 114), and a CQI is generated in response to the adjusted SINRs (block 116). The CQI estimate is then transmitted to the network 10.

By reducing the SINR estimates for each transmission mode when data are erroneously decoded, more accurate CQI estimates are generated, allowing the receiver BLER to more closely track a targeted BLER.

While the present invention has been described herein as being implemented in a UE, those of skill in the art will readily recognize that the downlink SINR back-off value may be calculated in the base station, rather than the UE, based on the CQI and ACK/NACK reports fed back from UEs, and the known transmission scheme corresponding to the ACK/NACK report. The base station may use an SINR back-off value it calculates to modify the CQI reported by UEs. The SINR back-off value calculated in the base station may not be as accurate as one calculated in the UE, since the base station has much less information available, in the sense that the reported CQI might not contain the full SINR information.

Of course, the base station may also implement the inventive SINR back-off operation to adjust SINR estimates decoding uplink transmissions, to better track a BLER target for uplink transmission.

Those of skill in the art will readily recognize that the functional blocks depicted in FIGS. 2 and 3 may be implemented as hardwired or programmable electronic circuits, as software modules executing on a microprocessor or digital signal processor (DSP), or any combination of hardware, firmware, and software, as known in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of estimating channel quality in a wireless communication network operative to transmit signals in a plurality of modes, each mode transmitting data in one or more streams, comprising:
receiving data and reference signals in at least one stream;
decoding the data for each stream;
generating a data error indicator for each stream based on the decoded data;
generating channel and noise estimates;
generating a signal to noise and interference ratio (SINR) for each potential transmission mode based on the channel and noise estimates;
generating an SINR back-off value for each transmission mode in response to the data error indicators;
reducing or advancing each SINR by the corresponding SINR back-off value; and
estimating channel quality based on the adjusted SINR.

2. The method of claim 1 wherein the method steps are performed in a User Equipment (UE), the channel quality being estimated is the downlink channel, and further comprising:
calculating a Channel Quality Indicator (CQI) based on the adjusted SINRs; and
transmitting the CQI.

3. The method of claim 1 wherein the method steps are performed in a base station and the channel quality being estimated is the uplink channel, and further comprising:
calculating a Channel Quality Indicator (CQI) based on the adjusted SINRs; and
transmitting the CQI to at least one UE.

4. The method of claim 1 wherein each data error indicator is based on the result of a cyclic redundancy check (CRC).

5. The method of claim 1 wherein the amount of adjustment of the SINR back-off value is dependent on a delay value.

6. The method of claim 1 wherein the amount of adjustment of the SINR back-off value is dependent on a target data error rate.

7. The method of claim 1 wherein each SINR back-off value is bounded by predetermined values.

8. The method of claim 2 wherein calculating a Channel Quality Indicator (CQI) based on the reduced SINRs comprises calculating a data rate for each transmission mode based on the reduced SINR for that mode, and calculating the CQI based on the rates.

9. The method of claim 2 wherein generating a data error indicator based on the decoded data comprises generating a positive or negative acknowledge signal (ACK/NACK).

10. The method of claim 1 wherein the wireless communication network operates in a multiple input multiple output (MIMO) mode.

11. The method of claim 10 wherein each transmission mode comprises a MIMO rank.

12. The method of claim 1 wherein generating channel and noise estimates comprises using successive interference cancellation (SIC), and wherein each transmission mode comprises a code word.

13. The method of claim 1 wherein generating channel and noise estimates comprises using successive interference cancellation (SIC), and wherein each transmission mode comprises a data stream originating from a different source.

14. The method of claim 13 wherein SIC is employed in a MIMO system and wherein one or more streams are intended for the receiver and one or more other streams are intended for other users.

15. A receiver operative in a wireless communication network that transmits signals in a plurality of transmission modes, each mode transmitting data in one or more streams, comprising:
a decoder operative to decode data in one or more streams, and to generate a data error indicator for each stream;
a channel estimator operative to generate channel and noise estimates; and
a Channel Quality Indicator (CQI) estimator receiving the data error indicators and the channel and noise estimates, and operative to generate a CQI report based on a reduced or advanced signal to noise and interference ratio (SINR) calculated for each transmission mode, each reduced or advanced SINR obtained by reducing or advancing an SINR calculated from the channel and noise estimates by a corresponding SINR back off value, the SINR back off value calculated in response to the data error indicators.

16. The receiver of claim 15 wherein the CQI estimator calculates the amount of adjustment of SINR back off values based on a delay value.

17. The receiver of claim 15 wherein the CQI estimator calculates the amount of adjustment of SINR back off values based on a target data error rate.

18. The receiver of claim 15 wherein the SINR back-off values are bounded by predetermined values.

19. The receiver of claim 15 wherein the CQI estimator is further operative to calculate a preferred data rate for each transmission mode based on the reduced SINR for that mode.

20. The receiver of claim 15 wherein the preferred data rate is the maximum data rate the receiver can accept without exceeding a predetermined data error rate.

21. The receiver of claim 15 wherein the CQI estimator is further operative to calculate a CQI indicator based on the rates.

22. A Channel Quality Indicator (CQI) estimator for a receiver operative in a wireless communication network that transmits signals in one of a plurality of transmission modes, each mode transmitting data in one or more streams, comprising:
an input configured to receive a data error signal associated with each received stream;
inputs configured to receive channel and noise estimates;
a signal to noise and interference ratio (SINR) back off calculator operative to generate an SINR back-off value for each transmission mode;
a plurality of SINR modules, each operative to calculate an SINR for a different transmission mode in response to the channel and noise estimates, and further operative to reduce or advance the SINR by a respective SINR back-off value.

23. The CQI estimator of claim 22 further comprising a plurality of data rate calculation modules, each receiving a respective reduced SINR and operative to calculate a preferred data rate for each corresponding transmission mode.

24. The CQI estimator of claim 23 wherein the preferred data rate is the maximum data rate the receiver can accept without exceeding a predetermined data error rate.

25. The CQI estimator of claim 23 further comprising a CQI report module receiving the preferred data rate for each transmission mode and operative to provide a CQI report in response to the data rates.

26. The CQI estimator of claim 25 further comprising an output configured to provide the CQI report.

27. A method of estimating downlink channel quality in a wireless communication network base station operative to transmit signals in a plurality of modes, each mode transmitting data in one or more streams, comprising:
transmitting data and reference signals in at least one stream;
receiving from at least one User Equipment (UE) a data error indicator for each stream, the data error indicator based on the UE decoding the transmitted data;
receiving a Channel Quality Indicator (CQI) from at least one UE; and
generating an SINR back-off value in response to the received data error indicators, the received CQI, and knowledge of the transmission mode.

28. The method of claim 27 further comprising:
generating a modified Channel Quality Indicator (CQI) based on the generated SINR back-off value and the received CQI.
